(19) United States
(12) Patent Application Publication
(10) Pub. No.: US 2025/0326663 A1
(43) Pub. Date: Oct. 23, 2025

(54) APPARATUS AND METHOD FOR PFAS REMOVAL VIA SURFACE EXCESS REMOVAL AND PFAS ADSORBENT MEDIA

(71) Applicant: EZRATERRA, LLC, Sisters, OR (US)

(72) Inventor: Patrick Richard BRADY, Sisters, OR (US)

(21) Appl. No.: 19/183,605

(22) Filed: Apr. 18, 2025

Related U.S. Application Data
(60) Provisional application No. 63/636,067, filed on Apr. 18, 2024.

(51) Int. Cl. C02F 1/28; C02F 101/36

(52) U.S. Cl. CPC C02F 1/283; C02F 2101/36; C02F 2301/022

(57) ABSTRACT

Methods and apparatus that include a flow channel in which a PFAS-containing fluid is flowing in a flow direction from an upstream direction to a downstream direction, with a plurality of elongate structures disposed vertically in the flow channel, where each elongate structure has a substantially concave face, and each elongate structure is disposed so that the substantially concave face is oriented facing the upstream direction; where a bulk of the PFAS-containing fluid exhibits a turbulent flow, but each elongate structure is configured to create at least one vertical eddy region in which the PFAS-containing fluid exhibits laminar flow.

### TECHNICAL FIELD

The present disclosure relates generally to environmental remediation, and more particularly to the collection, removal, and/or remediation of per- and polyfluoroalkyl substances (PFAS) in contaminated media.

### BACKGROUND

Per- and polyfluoroalkyl substances (PFAS or PFASs) are a group of synthetic organofluorine compounds that include multiple fluorine atoms attached to a hydrocarbon chain. As a result of this composition, PFASs can exhibit many desirable properties for industrial applications, including enhanced chemical stability and water-resistance. Fluorinated surfactants, in particular, have been found to be much more effective at reducing the surface tension of water than comparable hydrocarbon surfactants, and so have found widespread industrial use.

Unfortunately, the increasing prevalence of PFASs has resulted in an increasing release of PFASs into the environment, where their chemical stability and resistance to decomposition by natural processes have led them to be labeled “forever chemicals”. Only recently have the extent of the environmental impact and the toxicity of PFASs begun to be studied in depth, but PFAS exposure has already been linked to increased risk of dyslipidemia (abnormally high cholesterol), suboptimal antibody response, reduced infant and fetal growth, and higher rates of kidney cancer, among other health effects. The manufacture and use of PFASs has therefore come under increased scrutiny and regulation, in the US and other countries.

Environmental regulation has historically focused on the behavior of individual chemicals, their toxicity, and characteristic properties. An exception is regulation of non-aqueous phase liquids, including petroleum products such as gasoline and diesel. These formulations include a range of individual hydrocarbon compounds and additives, and are considered to be Light Non-Aqueous Phase Liquids (LNAPLs). When released to the environment these LNAPLs typically occur at the top of the capillary fringe above the water table, where they can be measured easily. Investigation and remediation of a chemical or petroleum fuel release is assessed by analyzing samples and comparing the results to a numeric standard.

This approach is consistent with the nature of the classic contaminants released to the environment. For example, gasoline contains a maximum of 3% additives with the remaining mass being various hydrocarbons. Remedial efforts for spilled gasoline can be evaluated through an analysis of all hydrocarbons that correspond to those that fall within the gasoline hydrocarbon range. The entire mixture of gasoline related compounds can be measured, and the behavior of those compounds in the environment is well understood.

However, PFASs are typically released into the environment as part of a colloidal formulation, and not as an individual PFAS compound. These PFAS-stabilized formulations are complex systems, with the amount of PFAS surfactant that creates the formulation being generally less than 1% of the mass of the entire formulation. These colloidal formulations are “surfactant-water-oil” systems, as opposed to simple mixtures of surfactants dissolved in water. The properties and behaviors of the PFAS formulation are typically dramatically different from those of either water or a pure PFAS.

Current technologies for collecting and removing PFAS typically include treatment with foam fractionation, where the collected PFAS formulation is converted into foam for safe removal. However, foam fractionation converts the fluid into a partially functional state where the foam structure cannot be sustained. The effluent from these foam fractionation methods is typically treated with one or more sorbents-materials intended to absorb or adsorb one or more components of the effluent-such as granular activated carbon (GAC). Unfortunately, sorbent treatment is less effective when the fluid is a partially functional system (i.e. where the foam structure is not sustained). Partially functional systems typically require treatment prior to sorbent treatment, as the presence of a surface excess monolayer of PFAS results in the sorbents becoming quickly spent and requiring frequent changes of the sorbent material.

In addition, sorbent treatments are less effective when fluid flow is turbulent. A solution has been to expand the size and cross-sectional area of sorbent beds in order to convert turbulent flow conditions to a more laminar flow. This, unfortunately, substantially increases sorbent cost, particularly when the fluid system passing through the sorbent beds may be only partially functional, resulting in fouling of the sorbent, and adding to an already high operational cost. High flow rates through undersized sorbent beds can in fact cause PFAS to leach from the sorbents back into the fluids under treatment.

What is needed is a way to improve the current methodologies of PFAS removal, and in particular to optimize sorbent treatments of contaminated fluids in high flow situations, preferably by taking advantage of the unique properties of PFAS formulations.

### SUMMARY

The present disclosure is directed to methods and apparatus for reducing PFAS concentrations in a flowing fluid, where the apparatus includes a flow channel in which the PFAS-containing fluid is flowing in a turbulent flow, and where the flow channel includes a plurality of elongate structures disposed vertically in the flow channel. Each elongate structure exhibits a substantially concave face that oriented towards the upstream direction of the flow, so that while a bulk of the PFAS-containing fluid exhibits a turbulent flow, the elongate structures create vertical eddy regions in which the PFAS-containing fluid exhibits laminar flow.

In one example, the present disclosure is directed to an apparatus that includes a flow channel in which a PFAS-containing fluid is flowing in a flow direction from an upstream direction to a downstream direction, a plurality of elongate structures disposed vertically in the flow channel, where each elongate structure has a substantially concave face, and each elongate structure is disposed so that the substantially concave face is oriented facing the upstream direction; such that a bulk of the PFAS-containing fluid exhibits a turbulent flow, but each elongate structure is configured to create at least one vertical eddy region in which the PFAS-containing fluid exhibits laminar flow.

In another example, the present disclosure is direct to an apparatus for removing PFAS from a fluid, the apparatus including a first flow chamber in which a PFAS-containing fluid is flowing in a flow direction from a first upstream direction to a first downstream direction, and a second flow chamber disposed downstream of and in series with the first flow chamber in which the PFAS-containing fluid is flowing in a flow direction from a second upstream direction to a second downstream direction. The first flow chamber includes a plurality of first elongate structures disposed vertically in the first flow chamber, where each elongate structure has a substantially concave face, and each elongate structure is disposed so that the substantially concave face is oriented facing the first upstream direction such that a bulk of the PFAS-containing fluid exhibits a turbulent flow, but each first elongate structure is configured to create at least one vertical eddy region in which the PFAS-containing fluid exhibits laminar flow and thereby provides a path upwards for PFAS to collect at or near a surface of the PFAS-containing fluid. The second flow chamber includes a plurality of second elongate structures disposed vertically in the second flow chamber, where each elongate structure has a substantially concave face, and each elongate structure is disposed so that the substantially concave face is oriented facing the second upstream direction, and a plurality of vertically-oriented channels each enclosing a sorption media; such that a bulk of the PFAS-containing fluid exhibits a turbulent flow, but each second elongate structure is configured to create at least one vertical eddy region in which the PFAS-containing fluid exhibits laminar flow and thereby provides a region of enhanced contact time between PFAS and the sorption media.

In another example, the present disclosure is directed to a method that includes creating a flow of a PFAS-containing fluid in a flow chamber so that the PFAS-containing fluid has a flow direction from an upstream direction to a downstream direction; and disposing a plurality of elongate structures vertically in the flow channel, each elongate structure having a substantially concave face oriented to face the upstream direction; so that a bulk of the PFAS-containing fluid exhibits a turbulent flow, but each elongate structure creates at least one vertical eddy region in which the PFAS-containing fluid exhibits laminar flow.

The apparatus and methods of the present disclosure are provided in greater detail in the drawings and detailed description below, and include all suitable combinations of the various examples and aspects provided therein.

### BRIEF DESCRIPTION OF THE DRAWINGS

FIG. 1 is an emergent behavior curve for fluid that includes PFAS, showing a relationship between static surface tension and PFAS concentration.

FIG. 2 is a schematic diagram showing the formation of eddy regions upstream and downstream of an exemplary drag-creating structure, according to the present disclosure.

FIG. 3 is a schematic diagram showing the formation vertically-oriented eddy regions upstream and downstream of an exemplary drag-creating structure, according to the present disclosure.

FIG. 4 is a flowchart for an exemplary method according to the present disclosure.

FIG. 5 semi-schematically depicts an exemplary facility for the removal of PFAS from a fluid, according to the present disclosure.

FIG. 6 depicts the surface excess PFAS removal chamber of the facility of FIG. 5.

FIG. 7 depicts the sorption media tank of the facility of FIG. 5.

### DETAILED DESCRIPTION OF PREFERRED EMBODIMENTS

As the present disclosure relates to the collection, removal, and/or remediation of contaminants such as per- and polyfluoroalkyl substances, or PFAS, it is therefore related to previous US Patents such as U.S. Pat. No. 10,875,062 to Brady, U.S. Pat. No. 11,413,668 to Brady, U.S. Pat. No. 11,484,922 to Brady, U.S. Pat. No. 11,768,189 to Brady, U.S. Pat. No. 12,092,557 to Brady, and U.S. patent application Ser. No. 18/646,515 “EMERGENT BEHAVIOR-BASED STRATEGIES FOR ENVIRONMENTAL PFAS REMEDIATION” filed Apr. 25, 2024, each of which is hereby incorporated by reference for all purposes.

In fluid dynamics the Reynolds number (Re) is a dimensionless quantity derived from the ratio between inertial forces and viscous forces in the fluid. The value of the Reynolds number can help predict whether fluid flow will be laminar (a smooth, sheet-like flow) or turbulent (chaotic). At low Reynolds numbers, flows tend to be dominated by laminar flow, while at high Reynolds numbers flows tend to be turbulent.

Reynolds number values of 2,000 and below are associated with laminar flow conditions (low flow) that enhance sorbent effectiveness, while Reynolds number values above 4,000 are associated with turbulent flow conditions (high flow) that are not ideal for sorbent effectiveness. The Reynolds number of a fluid system can, however, be modulated by the placement of objects in the path of the flowing fluid. Such objects can create drag, and associated drag envelopes, based upon their shape, where the drag envelope typically includes a localized area of low flow around the object. Objects of different shapes can create different drag envelope characteristics, and the resulting drag envelope size is typically proportional to the flow velocity squared. In other words, such drag envelopes tend to increase in size quickly as the rate of fluid flow increases.

The present disclosure is directed to systems and methods for enhancing the collection of PFAS contaminants from a fluid flow by modifying the fluid flow to create regions of laminar flow. In one aspect of the disclosure, the regions of laminar flow help to accelerate the collapse of PFAS-dependent foam structures in the fluid, and result in the liberation of PFAS as the foam collapses. In another aspect of the disclosure, regions of laminar flow can be used to enhance sorbent treatment of fluids, resulting in greater removal of PFAS from the fluids, and making the sorbent treatment more practical and cost-effective.

As used herein, “PFAS” refers to Perfluoroalkyl and Polyfluoroalkyl Substances, and can include one or more of PFAS monomers, PFAS oligomers, PFAS formulations, and PFAS supramolecular structures, without limitation and in any ratio and combination.

As used herein a “fluid” is a liquid, gas, or other material that is capable of continuous movement and deformation. That is, a fluid is a material that flows. Typically, but not exclusively, the PFAS-containing fluids disclosed herein are aqueous or at least partially aqueous fluids.

PFAS-containing fluids can behave as non-Newtonian fluids having pseudoplastic and thixotropic properties. When subjected to increasing shear stress, the viscosity of such fluids can be reduced, but recoils over time when the shear stresses are removed.

Such PFAS-containing fluids can be emergent systems that exhibit non-linear behavior that changes depending on the concentration of the PFAS components in the fluid. Put another way, the properties of an emergent systems can be distinctly different from the individual properties of its constituent components.

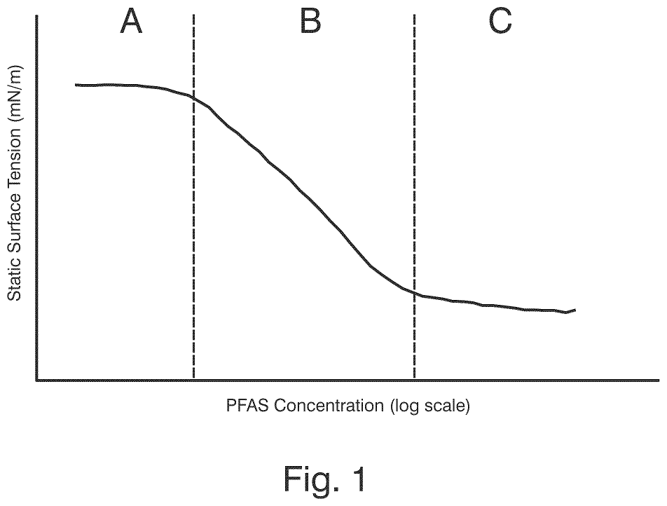

Referring to the plot of FIG. 1, the region A corresponds to measurements made using lower concentrations of PFAS. At these concentrations the amount of PFAS present in the mixture is insufficient to promote self-aggregation of the PFAS molecules, and the properties of the formulation can behave in a linear fashion, and with static surface tension gradually decreasing as PFAS formulation concentration increases. In this region, the dynamic surface tension of the mixture does not change with changes in concentration, and the fluid behaves as a Newtonian fluid. Typically, the PFAS formulation concentrations for region A correspond to a value below the median lethal concentration, or LC50, of that PFAS formulation, where LC50 (or LD50, the median lethal dose) corresponds to the dose required to kill half the members of a tested population after a specified test duration.

Where the static surface tension measured for a localized environmental sample indicates that PFAS formulation concentration at that location falls within region A of the plot of FIG. 1, the PFAS present at that location will not exhibit spontaneous self-assembly, or form more complex structures existing as dispersed PFAS. More significantly, the PFAS present at that concentration will not spontaneously shed additional PFAS. As the behavior of the fluids in region A behave like a Newtonian fluids, region A of the plot of FIG. 1 may be referred to as the “non-functional dispersive region”. The PFAS concentration range corresponding to the non-functional dispersive region can be referred to as the non-functional dispersive concentration range.

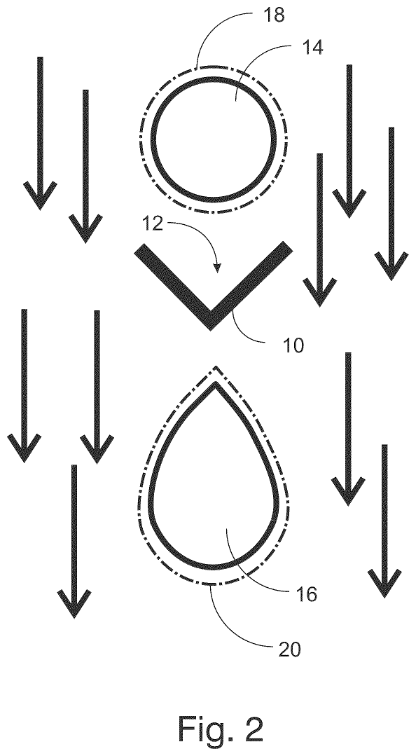

As PFAS concentration increases, there is a steep decrease in static surface tension in region B of the plot of FIG. 2. In this region, the static surface tension of the PFAS-containing fluids depends upon PFAS formulation concentration as a power law function. That is, the plot of static surface tension varies as the logarithm of the concentration, resulting in an overall linearity in region B. This region may be referred to as a “power law region,” or as the “weak functionality” region, where a small change in one variable results in a large change in the behavior of the system. The PFAS concentration range corresponding to the weak functionality region can be referred to as the weak functionality concentration range.

Within region B, as PFAS concentration increases, the dynamic surface tension in the bulk of the PFAS-containing fluid begins to decrease with the static surface tension, and the mixture exhibits non-Newtonian behavior. In this region laminar structures can form spontaneously, indicating that the creation of such aggregates is energetically favored. PFAS toxicity for solutions having a concentration within region B are above the median lethal concentration (LD50) but below the lethal concentration (LC or LC100) for that PFAS formulation. In this region, autopolymerization of PFAS takes place, resulting in the formation of microemulsions. The spontaneous creation of such PFAS aggregates results in the shedding of PFAS from the PFAS-containing fluids, which accumulates at or near the surface of the fluid.

As PFAS concentration increases still further, the plot of FIG. 1 enters region C, or the “fully functional region”. The PFAS formulation concentration range corresponding to the fully functional region can be referred to as the fully functional concentration range.

PFAS concentration levels in region C begin at the critical micelle concentration (CMC), and remain above the lethal concentration (LC). The PFAS-containing fluid exhibits the formation of PFAS-stabilized micelles in the bulk of the mixture. As the surface of the formulation in this region is completely saturated with PFAS, there is substantially no further decrease in static surface tension as concentration increases further, although dynamic surface tension can substantially decrease in this region. The formulation exhibits non-Newtonian behavior, and the PFAS molecules spontaneously form micelles as well as regions of liquid crystal structures.

The apparatus of the present disclosure are configured to facilitate at least partial removal of PFAS (including one or more of PFAS monomers, PFAS oligomers, PFAS formulations, and PFAS supramolecular structures) from a fluid. The apparatus includes a flow channel in which the PFAS-containing fluid is flowing from an upstream direction to a downstream direction. Multiple drag-creating structures are disposed vertically in the flow channel, where each drag structure has an associated drag coefficient greater than 2.0.

While the bulk of the PFAS-containing fluid exhibits a turbulent flow, the drag-creating structures are designed so that the PFAS-containing fluid is slowed by the drag-creating structures sufficiently to create at least one eddy region in which the PFAS-containing fluid exhibits laminar flow.

In one aspect of the present disclosure, where the drag-creating structures are disposed in the flow with a vertical orientation, the resulting eddy regions also have a vertical orientation, resulting in the creation of eddy regions that in turn provide a path for PFAS in the fluid to migrate upwards. The contributions of PFAS from each of the drag-creating structures then leads to the formation of a surface excess of PFAS on the surface of the flow.

In another aspect of the present disclosure, the eddy regions created by the drag-creating structures exhibit laminar flow, and are used to extend the contact time between the PFAS-containing fluid and a sorption agent that is configured to remove PFAS from the fluid.

In a preferred aspect of the present disclosure, the apparatus includes a first flow chamber in which the presence of the drag-creating structures results in a surface excess of PFAS, and a second flow chamber in series with the first flow chamber that includes sorption agents to remove additional PFAS from the flowing fluid.

The drag-creating structures of the present methods and apparatus are typically elongate structures that are disposed vertically in the appropriate flow channel. Each elongate structure has a substantially concave face, and each elongate structure is disposed in the flow channel so that the substantially concave face of the structure is oriented facing the upstream direction.

It may be advantageous for the elongate structures to include an elongate (vertically-oriented) metal plate that forms the substantially concave face. In particular, the elongate metal plates may be configured so that when viewed in horizontal cross-section the metal plates define two legs that meet at an angle that is less than 180 degrees. Preferably, the metal plates define an angle that is between about 75 degrees and 150 degrees, and more preferably, the metal plates define an angle that is about 90 degrees. In the latter embodiment, it may be beneficial to use angle irons as drag-creating structures.

The effect of an elongate drag-creating structure on fluid flow is shown in FIG. 2, which depicts a horizontal cross-section through an elongate drag-creating structure 10. Arrows indicate the direction of fluid flow. Drag-creating structure 10 is oriented so that a substantially concave face 12 faces the upstream direction. As a result, drag-creating structure 10 disrupts the turbulent fluid flow, creating two eddy regions. A first eddy region 14 occurs upstream of the drag-inducing structure, while a second eddy region 16 occurs downstream of the drag-inducing structure. The eddy regions may also be referred to as drag envelopes.

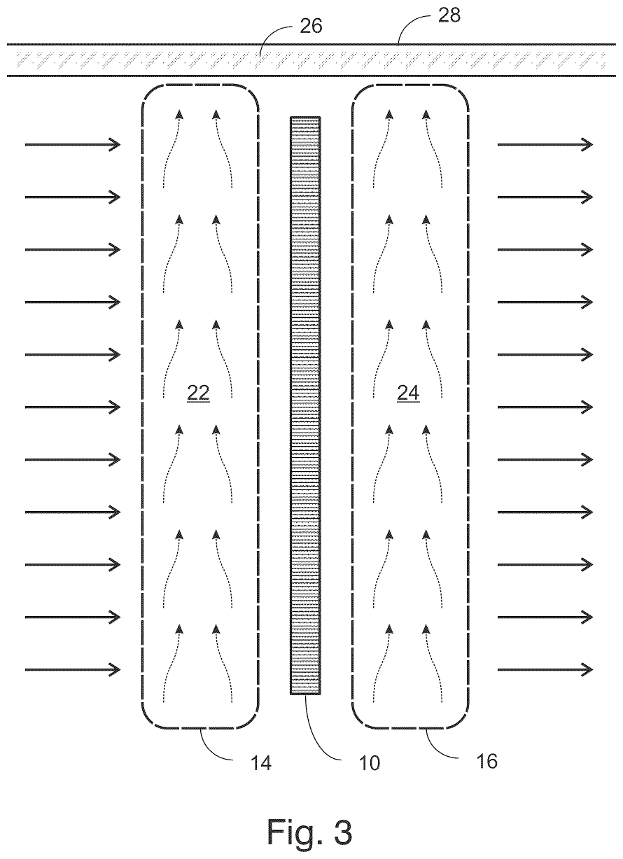

Within each eddy region 14 and 16, a laminar flow is achieved, where laminar flow is defined as flow having a Reynolds number less than 2,000. Outside the eddy regions 14 and 16 the flow remains turbulent, with a Reynolds number exceeding a threshold of between 2,000 and 4,000. Each boundary between turbulent flow and the laminar flow in the eddy region includes a shear plane and a transition zone referred to as the Kelvin-Helmholtz boundary 18, 20. FIG. 3 shows a vertical cross section of fluid flow, indicated by the horizontal arrows, with drag-inducing structure 10 within the flow and eddy regions 14 and 16 before and after structure 10.

The Kelvin-Helmholtz boundary (or KHB) is an interface between two fluids with different velocities and densities. The difference in flow rates across the boundary creates wave structures as the fluids mix. This instability controls the transport of mass, energy, and momentum between the fluids. The vortices created by the instability facilitate particle entry and loss. Fluids are constantly moving in and out of the drag envelope through the KHB.

The creation of the eddy regions 14 and 16 can facilitate PFAS removal in two ways. As shown in FIG. 3, eddy regions 14 and 16 can create vertical channels 22, 24 in which the lower fluid velocity and lower turbulence allows PFAS to move upwardly. This migration of PFAS results in a surface excess of PFAS 26 at or near surface 28 of the fluid in the flow channel. Surface excess PFAS 26 can then be collected and removed more easily.

Alternatively, or in addition, a sorption media selected to entrap PFAS can be disposed so that it at least partially overlaps with eddy regions 14 and 16, such that the lower fluid velocity and lower turbulence within the eddy regions results in enhanced contact and enhanced contact duration between the PFAS-containing fluid and the sorption media, thereby enhancing the ability of the sorption media to remove PFAS.

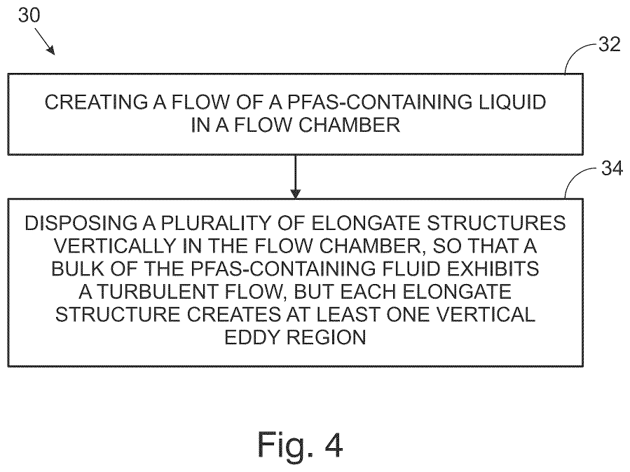

The presently disclosed apparatus lends itself to a method, as shown in flowchart 30 of FIG. 4, the method including: creating a flow of a PFAS-containing fluid in a flow chamber, where the PFAS-containing fluid has a flow direction from an upstream direction to a downstream direction, at 32 of flowchart 30; disposing a plurality of elongate structures vertically in the flow channel, where each elongate structure has a substantially concave face oriented to face the upstream direction, so that so that a bulk of the PFAS-containing fluid exhibits a turbulent flow, but each elongate structure creates at least one vertical eddy region in which the PFAS-containing fluid exhibits laminar flow, at 34 of flowchart 30.

The presently disclosed apparatus may include one or both of two stages:

Stage 1 is configured to provide increased surface area to facilitate PFAS formulations below the flow surface to rise to the surface of the fluid, as described above. Drag-creating structures can be used to create eddy regions up-stream and down-stream of the drag-creating structures where the eddy regions exhibit a lower Reynolds number and lower flow velocity such that PFAS moves upwards within the eddy region and concentrates at the surface.

Stage 2 is configured to provide a flow chamber with drag-creating structures in order to provide increased contact time between the PFAS-containing fluid and a sorption media.

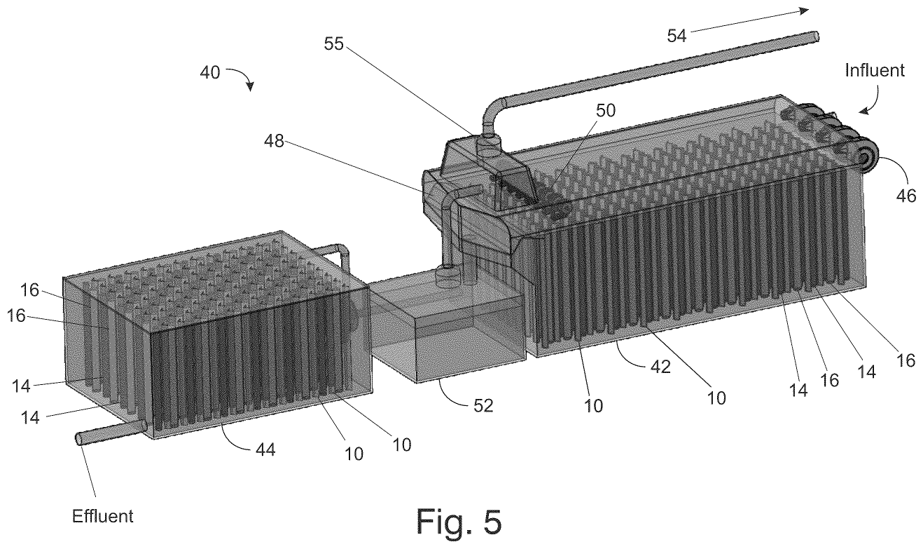

A facility 40 for carrying out the processes of Stage 1 and Stage 2, in series, is shown in FIGS. 5-7. As depicted, the facility 40 includes a surface excess PFAS removal chamber 42, in which the stage 1 process can be performed, and a sorption media chamber 44, in which the stage 2 process can be performed.

Surface excess PFAS removal chamber 42 can be used as a flow chamber, and includes a plurality of drag-creating structures 10, that may be the same or different. Each drag-creating structure 10 creates two eddy regions 14 and 16, as shown. In FIG. 5, the upstream direction of the fluid flow is to the right, and the downstream direction is to the left.

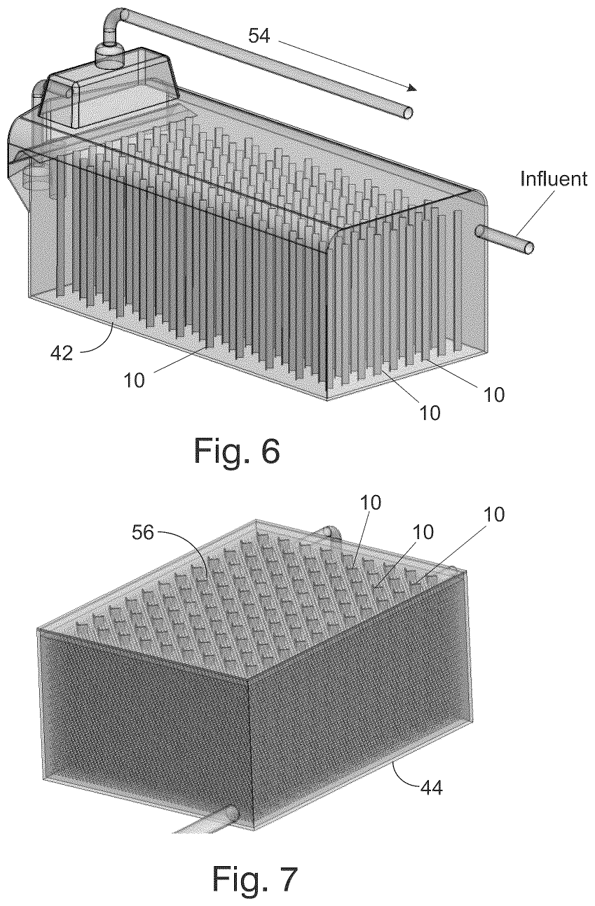

Surface excess PFAS removal chamber 42 is shown in greater detail in FIG. 6. In particular, drag-creating structures 10 are shown, but depictions of eddy regions 14 and 16 have been removed. In FIG. 6, the upstream direction of the fluid flow is to the right, and the downstream direction is to the left.

The configuration of surface excess PFAS removal chamber 42 permits increased PFAS to move out of the bulk fluid, and to concentrate at or near the surface of the fluid, as described above. Removal chamber 42 can include one or more blowers 46 that can direct air flow across the surface of the fluid within the chamber, urging the PFAS-enriched surface fluid to move to an exit ramp 48, where additional high-speed surface blowers 50 urge the surface fluid over exit ramp 48 and then to surface excess recovery tank 52.

Air can be drawn from surface excess recovery tank 52 that may be directed to an emission treatment device 54 (not shown), perhaps after passing through a demister screen 55. As the surface excess of PFAS is continuously removed, it permits additional PFAS to move from the bulk fluid to a layer at or near the surface. The recovered surface excess fluid can be periodically removed from surface excess recovery tank 52 for additional treatment, such as for example by a brine pot evaporator, as described in U.S. Pat. No. 11,413,668.

Any other method for collecting and/or transporting the PFAS-enriched surface fluid created within surface excess PFAS removal chamber 42 may be used to collect the surface excess recovery fluid. For example, a moving belt may be used as a surface skimmer, or moving paddles may direct the surface fluid to an exit from removal chamber 42. While removal chamber 42 includes an exit for PFAS-containing fluid after surface excess treatment, removal chamber 42 may additionally include one or more bottom exits in order to facilitate the removal of denser contaminants from the chamber, if needed.

The initially treated PFAS-containing fluid can then be directed to the sorption media chamber 44, where the presence of drag-creating structures 10 creates multiple eddy regions 14 and 16, as shown, that in turn increase the contact time between the fluid undergoing treatment and a sorption media 56, which is present within sorption media chamber 44, and disposed therein so as to reside at least partially within one of the eddy regions 14 and 16.

Sorption media 56 may be contained by and/or disposed within porous media containers, where the porous media containers are installed so that the sorption media 56 resides at least partially within one of the eddy regions 14 and 16. More preferably, sorption media 56 has a particulate or granular conformation, such that sorption media 56 can occupy the space around drag-creating structures 10 in sorption media chamber 44, as shown in FIG. 7. The conformation of sorption media 56 should be porous enough that fluid flow can occur through sorption media chamber 44, and eddy regions 14 and 16 are formed due to that fluid flow. In FIG. 7, the upstream direction of the fluid flow is to the right, and the downstream direction is to the left.

In any event, sorption media 56 should be present in a form that can be removed and replaced, or regenerated if appropriated, when its PFAS capacity is reached, or the sorption media 56 is otherwise rendered less effective.

A variety of sorption media may be used to adsorb or absorb PFAS from the PFAS-containing fluids, including one or more of activated carbon (granular activated carbon and/or powdered activated carbon), functional clay, metal-organic adsorbents, functionalized organic polymers, and biochar from agricultural or food waste, or sewage sludge from wastewater treatment.

Although facility 40 is depicted as having a stage 1 process (surface excess PFAS removal chamber 42) and a stage 2 process (sorption media chamber 44), such treatment facilities are not limited to this configuration. A surface excess PFAS removal chamber 42 can be placed in series with two or more sorption media chambers, each utilizing perhaps the same or different sorption media.

It should be appreciated that the progress and efficacy of the presently disclosed treatment methods can be monitored, for example in real time. In particular, static surface tension measurements can be made before treatment, after treatment, and/or between each treatment stage in order to assess treatment effectiveness in real time.

The presently disclosed apparatus and methods may be used to increase PFAS removal efficiency from high flow, high velocity, and high Reynolds number (turbulent) water situations and to enhance removal efficiency for various PFAS adsorbents. The present apparatus and methods may therefore be advantageous when used with sewage treatment plants, landfill leachate treatment plants, drinking water treatment plants, and storm water treatment, among other applications.

In the description and the claims, the term “substantially” means a deviation of up to 10% of the stated value, if this is physically possible, both downwards and upwards, otherwise only in the sensible direction; for degrees (of angle and temperature) ±10° is meant.

All quantities and proportions, in particular those for delimiting the invention, as far as they do not relate to the specific examples, are to be understood with ±10% tolerance, thus, for example: 11% means: from 9.9% to 12.1%. For terms such as: “a microphone” the word “a” is not a numerical word but is to be regarded as the indefinite article or a pronoun, unless the context indicates otherwise.

The term: “combination” or “combinations” means, unless otherwise stated, all types of combinations, from two of the constituents concerned to a large number or all of such constituents; the term: “containing” may also be substituted with “consisting of”.

One of skill in the art that is familiar with the present disclosure may envision additional possible solutions, adjustments and effects for the fluid treatments disclosed herein, without departing from the spirit and scope of the appended claims. The characteristics and variants specified for the individual embodiments and examples disclosed herein may be freely combined with those of the other examples and embodiments and may in particular be used to characterize the invention in the claims without necessarily entraining the other details of the respective embodiment or the respective example.

What is claimed is:

1. An apparatus, comprising:
a flow channel in which a PFAS-containing fluid is flowing in a flow direction from an upstream direction to a downstream direction;
a plurality of elongate structures disposed vertically in the flow channel, where each elongate structure has a substantially concave face, and each elongate structure is disposed so that the substantially concave face is oriented facing the upstream direction;
wherein a bulk of the PFAS-containing fluid exhibits a turbulent flow, but each elongate structure is configured to create at least one vertical eddy region in which the PFAS-containing fluid exhibits laminar flow.

2. The apparatus of claim 1, wherein the bulk of the PFAS-containing fluid exhibits the turbulent flow with a Reynolds number exceeding a threshold of between 2,000 and 4,000, while the PFAS-containing fluid in the at least one vertical eddy region exhibits laminar flow with a Reynolds number less than 2,000.

3. The apparatus of claim 1, wherein each of the plurality of vertical elongate structures includes an elongate metal plate defining the substantially concave face that is oriented facing the upstream direction.

4. The apparatus of claim 3, wherein each elongate metal plate defines an angle between about 150 degrees and 75 degrees that is oriented facing the upstream direction, where the elongate metal plate has an associated drag coefficient greater than 2.0.

5. The apparatus of claim 1, wherein each of the plurality of vertical elongate structures includes an elongate angle iron defining the substantially concave face that is oriented facing the upstream direction, where each elongate angle iron defines an angle that is a right angle, and each elongate angle iron create a first vertical eddy region upstream of the elongate angle iron, and a second vertical eddy region downstream of the elongate angle iron.

6. The apparatus of claim 5, wherein each of the first and second vertical eddy regions provides a path upwards for PFAS to collect at or near a surface of the PFAS-containing fluid.

7. The apparatus of claim 5, wherein the flow channel further comprises a plurality of vertically-oriented channels enclosing a sorption media, and each of the first and second vertical eddy regions provides a region of enhanced contact time between PFAS and the sorption media.

8. The apparatus of claim 1, wherein the bulk of the PFAS-containing fluid has a PFAS concentration in a non-functional dispersive range to a weakly functional range.

9. An apparatus for removing PFAS from a fluid, comprising:
a first flow chamber in which a PFAS-containing fluid is flowing in a flow direction from a first upstream direction to a first downstream direction; the first flow chamber including:
a plurality of first elongate structures disposed vertically in the first flow chamber, where each elongate structure has a substantially concave face, and each elongate structure is disposed so that the substantially concave face is oriented facing the first upstream direction;
wherein a bulk of the PFAS-containing fluid exhibits a turbulent flow, but each first elongate structure is configured to create at least one vertical eddy region in which the PFAS-containing fluid exhibits laminar flow and thereby provides a path upwards for PFAS to collect at or near a surface of the PFAS-containing fluid;
a second flow chamber disposed downstream of and in series with the first flow chamber, in which the PFAS-containing fluid is flowing in a flow direction from a second upstream direction to a second downstream direction; the second flow chamber including:
a plurality of second elongate structures disposed vertically in the second flow chamber, where each elongate structure has a substantially concave face, and each elongate structure is disposed so that the substantially concave face is oriented facing the second upstream direction; and
a plurality of vertically-oriented channels each enclosing a sorption media;
wherein a bulk of the PFAS-containing fluid exhibits a turbulent flow, but each second elongate structure is configured to create at least one vertical eddy region in which the PFAS-containing fluid exhibits laminar flow and thereby provides a region of enhanced contact time between PFAS and the sorption media.

10. The apparatus of claim 9, the first flow chamber further comprising an air blower configured to blow air across a surface of the PFAS-containing flow in order to urge excess PFAS at the surface of the PFAS-containing flow to a down-stream exit from the first flow chamber.

11. The apparatus of claim 9, further comprising a vapor emissions treatment system for treating the air collected from the first flow chamber.

12. The apparatus of claim 9, wherein the sorption media of the second flow chamber includes activated carbon.

13. A method, comprising:
creating a flow of a PFAS-containing fluid in a flow chamber, the PFAS-containing fluid having a flow direction from an upstream direction to a downstream direction;
disposing a plurality of elongate structures vertically in the flow channel, each elongate structure having a substantially concave face oriented to face the upstream direction;
so that a bulk of the PFAS-containing fluid exhibits a turbulent flow, but each elongate structure creates at least one vertical eddy region in which the PFAS-containing fluid exhibits laminar flow.

14. The method of claim 13, wherein disposing the plurality of elongate structures vertically in the flow channel includes disposing elongate metal plates having a substantially concave face defining an angle between about 150 degrees and 75 degrees so that the substantially concave face is oriented facing the upstream direction.

15. The method of claim 13, wherein disposing the plurality of elongate structures vertically in the flow channel includes disposing elongate metal plates having a substantially concave face so that the substantially concave face is oriented facing the upstream direction, resulting in a drag coefficient greater than 2.0.

16. The method of claim 13, wherein disposing the plurality of elongate structures vertically in the flow channel includes disposing a plurality of elongate angle irons that define an angle that is a concave right angle so that the an elongate angle iron defining the face that is a concave right angle is oriented facing the upstream direction, each elongate angle iron creating a first vertical eddy region upstream of the elongate angle iron, and a second vertical eddy region downstream of the elongate angle iron.

17. The method of claim 16, each of the first and second vertical eddy regions providing a path upwards for PFAS to collect at or near a surface of the PFAS-containing fluid.

18. The apparatus of claim 13, further comprising disposing a plurality of vertically-oriented channels enclosing a sorption media in the flow chamber, such that each of the first and second vertical eddy regions provides a region of enhanced contact time between PFAS and the sorption media.
